(19) United States
(12) Patent Application Publication
(10) Pub. No.: US 2026/0208791 A1
(43) Pub. Date: Jul. 23, 2026

(54) Wheel Unit for Automated Guided Vehicle, and Automated Guided Vehicle

(71) Applicant: ABB Schweiz AG, Baden (CH)

(72) Inventor: Jonas Larsson, Västerås (SE)

(73) Assignee: ABB Schweiz AG, Baden (CH)

(21) Appl. No.: 19/566,178

(22) Filed: Mar. 13, 2026

Related U.S. Application Data
(63) Continuation of application No. PCT/EP2023/075923, filed on Sep. 20, 2023.

(51) Int. Cl. B62D 15/02; B62D 5/04

(52) U.S. Cl. CPC B62D 15/023; B62D 5/0418

(57) ABSTRACT

A wheel unit for an automated guided vehicle (AGV) includes a base structure; a steering structure rotatable relative to the base structure around a vertical steering axis; a wheel supported by the steering structure and rotatable relative to the steering structure around a horizontal wheel axis; a force device arranged to force the base structure and the steering structure away from each other along the steering axis; and a sensor arranged to sense a rotational position of the steering structure relative to the base structure around the steering axis and an axial position of the base structure relative to the steering structure along the steering axis.

### CROSS-REFERENCE TO RELATED APPLICATIONS

The instant application claims priority to International Patent Application No. PCT/EP2023/075923, filed September 20, 2023, which is incorporated herein in its entirety by reference.

### FIELD OF THE DISCLOSURE

The present disclosure generally relates to automated guided vehicles (AGVs) and, more particularly, to a wheel unit for an AGV.

### BACKGROUND OF THE INVENTION

Automated guided vehicles (AGVs) are typically self-powered, self-driven vehicles used to transport materials and other items from one location to another, without the need for a driver on the vehicle. AGVs are commonly used in manufacturing sites, warehouses, post offices, libraries, port terminals, airports, and some hazardous locations and specialty industries.

WO 2020259833 A1 discloses a wheel unit for an AGV. The wheel unit comprises a steering shaft, a driven steering member rotatable about a steering axis, a wheel rotatable about a wheel axis, and a steering sensor device arranged to determine a rotational position of the driven steering member about the steering axis.

### BRIEF SUMMARY OF THE INVENTION

The present disclosure generally describes an improved wheel unit for an automated guided vehicle (AGV). In one embodiment, adding a force device arranged to force a base structure vertically relative to a steering structure in a wheel unit comprising a sensor arranged to sense a steering position, the sensor can be upgraded to a sensor that can also sense an axial position at low cost and with small changes of the design of the wheel unit.

According to a first aspect, there is provided a wheel unit for an automated guided vehicle, AGV, the wheel unit comprising a base structure; a steering structure rotatable relative to the base structure around a vertical steering axis; a wheel supported by the steering structure and rotatable relative to the steering structure around a horizontal wheel axis; a force device arranged to force the base structure and the steering structure away from each other along the steering axis; and a sensor arranged to sense a rotational position of the steering structure relative to the base structure around the steering axis and an axial position of the base structure relative to the steering structure along the steering axis.

The provision of the force device and the sensor having dual functionality, i.e., arranged to sense both the rotational position and the axial position, enables a wheel unit, such as the wheel unit in WO 2020259833 A1, to be upgraded to provide a wide range of new functionality for the AGV at low cost and with small changes of wheel unit.

### BRIEF DESCRIPTION OF THE SEVERAL VIEWS OF THE DRAWING(S

FIG. 1 is a diagram of a perspective view of an automated guided vehicle (AGV) comprising a plurality of wheel units, in accordance with the disclosure.

FIG. 2 is a diagram of a cross-sectional side view of one of the wheel units of the AGV of FIG. 1.

FIG. 3 is a perspective view of a force device in accordance with the disclosure.

FIG. 4 is a diagram of a force device according to a further example in accordance with the disclosure.

FIG. 5 is a diagram of a force device according to a further example in accordance with the disclosure.

FIG. 6 is a diagram of a partial cross-sectional side view of a further example of a wheel unit in accordance with the disclosure.

FIG. 7 is a diagram of a partial cross-sectional side view of a further example of a wheel unit.

### DETAILED DESCRIPTION OF THE INVENTION

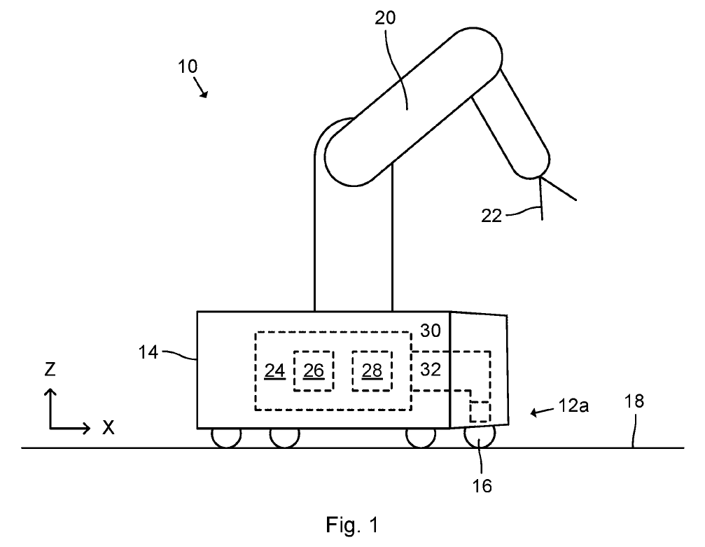

In the following, a wheel unit for an automated guided vehicle, AGV, and an AGV comprising a wheel unit, will be described. The same or similar reference numerals will be used to denote the same or similar structural features. FIG. 1 schematically represents a perspective view of an automated guided vehicle, AGV, 10. The AGV 10 comprises a plurality of wheel units 12a. The AGV 10 further comprises a base 14, here exemplified as a platform. In FIG. 1, the AGV 10 comprises four-wheel units 12a. The AGV 10 may however comprise fewer than four-wheel units 12a or more than four-wheel units 12a. In this specific example, the base 14 has a quadrangular shape and each wheel unit 12a is connected at a corner of the base 14.

Each wheel unit 12a comprises a wheel 16. Each wheel 16 is in contact with a ground surface 18, here as a horizontal floor. In this example, all wheel units 12a are of the same design, where each wheel 16 is a traction wheel for driving the AGV 10 over the ground surface 18. The wheel units 12a of the AGV 10 may however be of different designs. For example, not all of the wheels 16 need to be traction wheels. FIG. 1 further shows a Cartesian coordinate system X, Y, Z for reference purposes. In FIG. 1, the XY-plane is parallel with the ground surface 18 and the Z-axis is vertical.

The AGV 10 of this example further comprises an optional manipulator 20. The manipulator 20 of this example is a serial robotic arm programmable in three or more axes. The manipulator 20 comprises an end effector 22, here exemplified as a gripper, at a distal end of the manipulator 20. The manipulator 20 is supported on the base 14. By controlling the wheel units 12a to move the base 14 over the ground surface 18 and by controlling movements of the manipulator 20, the AGV 10 can perform various tasks, for example a first pick and place operation at a first location and a second pick and place operation at a second location remote from the first location.

The AGV 10 further comprises a control system 24. The control system 24 is here provided in the base 14. The control system 24 of this example comprises a data processing device 26 and a memory 28. The memory 28 has a computer program stored thereon. The computer program comprises program code which, when executed by the data processing device 26, causes the data processing device 26 to perform, or command performance of, various steps as described herein, including controlling any motors of the wheel units 12a and controlling the manipulator 20. As indicated in FIG. 1, each wheel unit 12a is arranged to send rotational position data 30 and axial position data 32 to the control system 24. The rotational position data 30 and the axial position data 32 are used by the control system 24 to perform various operations. The AGV 10 may also comprise a battery (not shown) for powering the control system 24, the wheel units 12a and the manipulator 20.

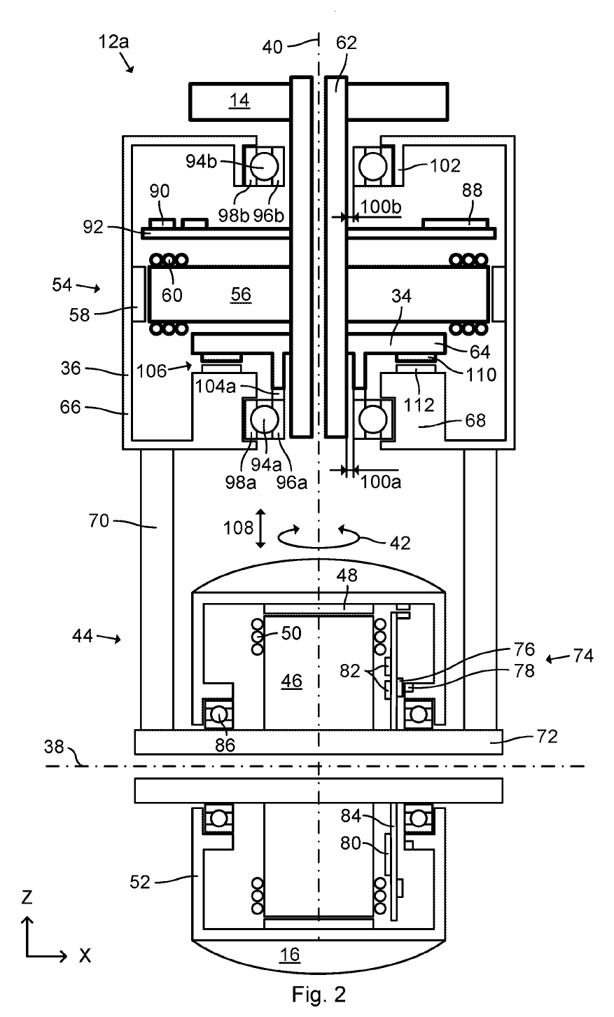

FIG. 2 schematically represents a cross-sectional view of one example of a wheel unit 12a of the AGV 10. In addition to the wheel 16, the wheel unit 12a comprises a base structure 34 and a steering structure 36. In FIG. 2, lines of exemplifying parts of the base structure 34 are drawn thicker than lines of exemplifying parts of the steering structure 36. The wheel 16 is supported by the steering structure 36 and is rotatable relative to the steering structure 36 around a horizontal wheel axis 38. The steering structure 36 is rotatable relative to the base structure 34 around a vertical steering axis 40. When the steering structure 36 rotates around the steering axis 40, also the wheel 16 rotates around the steering axis 40. The steering structure 36 and the wheel 16 can thus adopt various rotational positions 42 relative to the base structure 34 around the steering axis 40. The steering axis 40 and the wheel axis 38 are here intersecting each other. The steering axis 40 and the wheel axis 38 provide two degrees of freedom for the wheel unit 12a.

The wheel unit 12a of this example further comprises an electric drive motor 44 controlled by the control system 24. The drive motor 44 comprises a drive stator 46, a drive rotor 48 and drive coils 50 arranged on the drive stator 46. The drive motor 44 is arranged to rotationally drive the wheel 16 to rotate relative to the steering structure 36 around the wheel axis 38 to provide propulsion of the AGV 10. The wheel 16 in FIG. 2 is thus a traction wheel. In this example, the drive motor 44 is arranged to directly drive the wheel 16, i.e. without any intermediate gearing between the drive motor 44 and the wheel 16. As shown in FIG. 2, the drive motor 44 is arranged inside a hub 52 of the wheel 16.

The wheel unit 12a of this example further comprises an electric steering motor 54 controlled by the control system 24. The steering motor 54 comprises a steering stator 56, a steering rotor 58 and steering coils 60 arranged on the steering stator 56. The steering motor 54 is arranged to rotationally drive the steering structure 36 to rotate relative to the base structure 34 around the steering axis 40 to thereby provide steering of the AGV 10. The wheel 16 in FIG. 2 is thus also a steered wheel. In this example, the steering motor 54 is arranged to directly drive the steering structure 36, i.e. without any intermediate gearing between the steering motor 54 and the steering structure 36.

The base structure 34 of this specific and non-limiting example comprises a base shaft 62, a base support 64 and the steering stator 56. The base shaft 62 is fixed to the base 14. There is thus no relative movement between any of the base shaft 62, the base support 64, the steering stator 56 and the base 14. The base shaft 62 is here oriented vertically and coincident with the steering axis 40. The steering stator 56 and the base support 64 are fixed to the base shaft 62. In this example, the base support 64 is arranged below the steering stator 56.

The steering structure 36 of this specific and non-limiting example comprises the steering rotor 58, a housing 66, a steering support 68, two arm parts 70, a wheel shaft 72 and the drive stator 46. The housing 66 encloses the steering motor 54, a part of the base shaft 62, the base support 64 and the steering support 68. The arm parts 70 extend downward from the housing 66 and interconnect the housing 66 and the wheel shaft 72 in parallel. The wheel unit 12a may alternatively comprise only one arm part 70. The wheel shaft 72 is oriented horizontally and coincident with the wheel axis 38. The drive stator 46 is fixed to the wheel shaft 72. By driving the steering motor 54, the steering rotor 58, the housing 66, the steering support 68, the arm parts 70, the wheel shaft 72 and the drive stator 46 rotate in common around the steering axis 40 but there is no relative movement between these parts. As shown in FIG. 2, the steering support 68 of this example encloses the steering axis 40.

The wheel unit 12a of this example further comprises a drive sensor 74. The drive sensor 74 determines a rotational position of the wheel 16 around the wheel axis 38 and sends data indicative of this rotational position to the control system 24. The drive sensor 74 of this example comprises a sensing part 76, here fixed to the steering structure 36, and a target part 78, here fixed to the wheel 16.

The wheel unit 12a further comprises drive electronics 80 and transistors 82 arranged on a drive circuit board 84. Also the sensing part 76 is here provided on the drive circuit board 84. The drive electronics 80 control operation of the drive motor 44, for example by PWM control, and is in signal communication with the control system 24. The drive circuit board 84 is here fixed to the wheel shaft 72 and thus also forms part of the steering structure 36.

The wheel unit 12a of this example further comprises two wheel bearings 86. The wheel bearings 86 are arranged to support rotation of the wheel 16 relative to the steering structure 36 around the wheel axis 38.

The wheel unit 12a further comprises steering electronics 88 and transistors 90 arranged on a steering circuit board 92. The steering electronics 88 control operation of the steering motor 54, for example by PWM control, and is in signal communication with the control system 24. The steering circuit board 92 is here fixed to the base shaft 62 and thus also forms part of the base structure 34. In this example, the steering stator 56 is positioned between the steering circuit board 92 and the base support 64 along the steering axis 40.

The wheel unit 12a of this example further comprises a first steering bearing 94a and a second steering bearing 94b. The wheel unit 12a may alternatively comprise only the first steering bearing 94a, but not the second steering bearing 94b. Alternatively, the wheel unit 12a may comprise more than two steering bearings. Each of the first and second steering bearings 94a and 94b is arranged to support rotation of the steering structure 36 relative to the base structure 34 around the steering axis 40. The first and second steering bearings 94a and 94b, and the wheel bearings 86, are here exemplified as rolling element bearings. Alternative types of bearings, such as sliding bearings or magnetic bearings, are however conceivable.

The first steering bearing 94a comprises a base bearing race 96a and a steering bearing race 98a. The base bearing race 96a and the steering bearing race 98a are examples of a base bearing part and a steering bearing part, respectively. The base bearing race 96a is associated with the base structure 34 and the steering bearing race 98a is associated with the steering structure 36. In this example, the steering bearing race 98a is fixed to the steering structure 36, here to the steering support 68 thereof, but the base bearing race 96a is not fixed to the base structure 34. Instead, a radial gap 100a with respect to the steering axis 40 is provided between the base bearing race 96a and the base structure 34, here the base shaft 62 thereof. There is thus a loose tolerance fit between the base bearing race 96a and the base shaft 62.

The optional second steering bearing 94b comprises a base bearing race 96b and a steering bearing race 98b. In this example, the steering bearing race 98b is fixed to the steering structure 36, here to a flange 102 of the housing 66 thereof. The base bearing race 96b is not fixed to the base structure 34. Instead, a radial gap 100b with respect to the steering axis 40 is provided between the base bearing race 96b and the base structure 34, here the base shaft 62 thereof. There is thus a loose tolerance fit between the base bearing race 96b and the base shaft 62. Due to the gaps 100a and 100b, the base structure 34 and the steering structure 36 are allowed to move axially relative to each other along the steering axis 40.

The wheel unit 12a further comprises a spring washer 104a. The spring washer 104a is one of many examples of a force device according to the present disclosure. Some of the gravity load from the manipulator 20 generates a force on the base shaft 62 causing a deformation of the spring washer 104a, here a compression thereof. The spring washer 104a is arranged to force the base structure 34 and the steering structure 36 away from each other along the steering axis 40. For example, when the wheel 16 contacts the ground surface 18, the base structure 34 can move vertically downwards relative to the steering structure 36 along the steering axis 40 against the force from the spring washer 104a. As a further example, when the wheel 16 loses contact with the ground surface 18, the spring washer 104a can force the steering structure 36 to move vertically downwards relative to the base structure 34 along the steering axis 40.

The wheel unit 12a further comprises a steering sensor 106. The steering sensor 106 is arranged to measure the rotational position 42 of the steering structure 36 relative to the base structure 34 around the steering axis 40. The measured rotational position 42 is forwarded by the steering sensor 106 to the control system 24 as the rotational position data 30. The same steering sensor 106 is also arranged to measure an axial position 108 of the base structure 34 relative to the steering structure 36 along the steering axis 40. The measured axial position 108 is forwarded by the steering sensor 106 to the control system 24 as the axial position data 32. The steering sensor 106 thus provides dual functionality.

The steering sensor 106 is enclosed by the steering structure 36 around the steering axis 40. In this example, the steering sensor 106 is provided inside of the housing 66.

The steering sensor 106 of this example comprises a sensing part 110 fixed to the base structure 34, here fixed directly to the base support 64 thereof, and a target part 112 fixed to the steering structure 36, here fixed directly to the steering support 68 thereof. Alternatively, the sensing part 110 may be fixed to the steering structure 36 and the target part 112 may be fixed to the base structure 34. The sensing part 110 and the target part 112 may alternatively be referred to as an active part and a passive part, respectively, of the steering sensor 106.

Due to the force provided by the spring washer 104a, a vertical gap is established between the sensing part 110 and the target part 112. The gap may for example be less than 1 mm, such as 0.3 mm. The base structure 34 may therefore be said to float with respect to the steering structure 36 along the steering axis 40. When a vertically downward load acting on the base structure 34 increases, the spring washer 104a is compressed and vice versa. Based on the axial position data 32, this load can be determined by the control system 24, e.g., by considering the characteristics of the spring washer 104a and using Hooke's law. Such characteristics may comprise the stiffness of the spring washer 104a and/or can be determined beforehand, either before or after mounting of the spring washer 104a to the wheel unit 12a. In case spring washer 104a is not linear, the axial position data 32 may be calibrated with respect to the spring washer 104a. This can be done by applying known axial forces onto the base structure 34 and mapping the axial position data 32 as a function of the axial forces.

The steering sensor 106 may for example be a commercially available sensor. One example of such sensor is the absolute rotary encoder KCI 1319 sold by Heidenhain. This sensor has a resolution in the axial direction of about 1 μm. A further example of such sensor is of the type described in US patent US 10749412 B2, which is incorporated herein by reference.

By introducing the spring washer 104a and the steering sensor 106 with dual functionality, i.e., configured to measure both the rotational position 42 and the axial position 108, a prior art wheel unit, for example the wheel unit in WO 2020259833 A1, can be upgraded with very little extra hardware costs and design modifications to provide a wide range of additional functionalities for the AGV 10 as described herein. For example, based on the axial position data 32, the control system 24 can perform an operation, such as performing a motion control of the AGV 10, performing an inclination control of the AGV 10, determining an approximate load that is carried by the wheel 16, detecting an external force acting on the AGV 10, and/or estimating a remaining useful life of the AGV 10.

In FIG. 2, each of the spring washer 104a, the steering sensor 106 and the first steering bearing 94a is arranged between the base structure 34 and the steering structure 36, here between the base support 64 and the steering support 68. Moreover, the spring washer 104a and the first steering bearing 94a is arranged in series between the base structure 34 and the steering structure 36, here between the base support 64 and the steering support 68. The spring washer 104a contacts the base structure 34, here the base support 64 thereof, and the base bearing race 96a. The spring washer 104a may or may not be fixed to any of the base structure 34 and the base bearing race 96a. Although axial movement occurs at the spring washer 104a, no rotational movement may occur at the spring washer 104a between the base structure 34 and the base bearing race 96a.

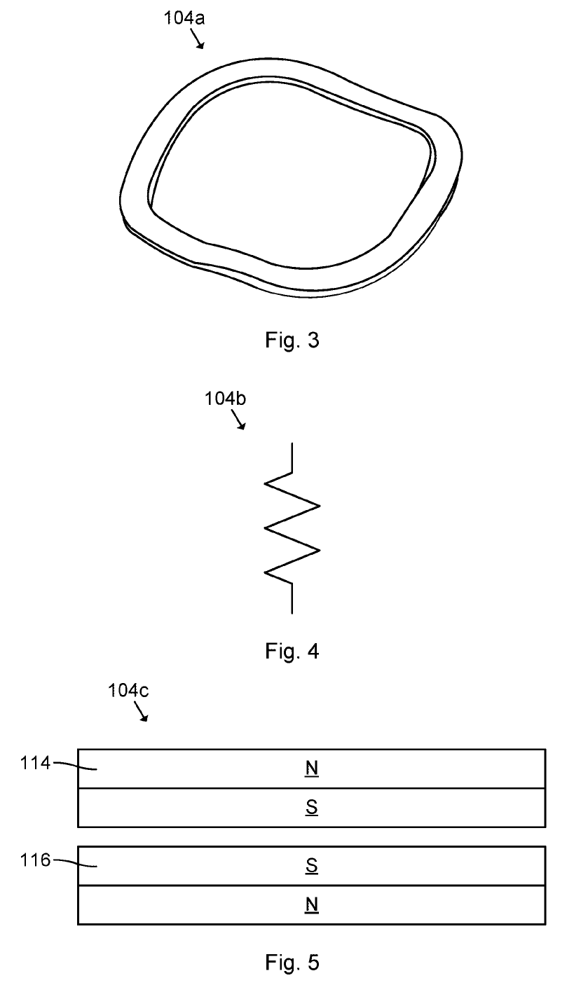

FIG. 3 schematically represents a perspective view of the spring washer 104a. The spring washer 104a may, for example, be made of metal. The spring washer 104a is here exemplified as a wave spring. Although the spring washer 104a of this example comprises only one turn, the spring washer 104a may alternatively comprise several turns. The number of waves for each turn may be varied.

FIG. 4 schematically represents a coil spring 104b. The coil spring 104b is a further example of a force device according to the present disclosure. Any of the wheel unit 12a-12c may alternatively comprise the coil spring 104b instead of the spring washer 104a.

FIG. 5 schematically represents a magnetic force device 104c. The magnetic force device 104c is a further example of a force device according to the present disclosure. The magnetic force device 104c of this example comprises a first magnetic part 114 and a second magnetic part 116 magnetically cooperating with the first magnetic part 114. For example, the polarities of the first and second magnetic parts 114 and 116 may be oriented to generate a repulsive magnetic force therebetween, as shown in FIG. 5. Any of the wheel unit 12a-12c may alternatively comprise the magnetic force device 104c instead of the spring washer 104a. In this case, the first magnetic part 114 may for example be fixed to the base structure 34 and the second magnetic part 116 may for example be fixed to the base bearing race 96a, or vice versa.

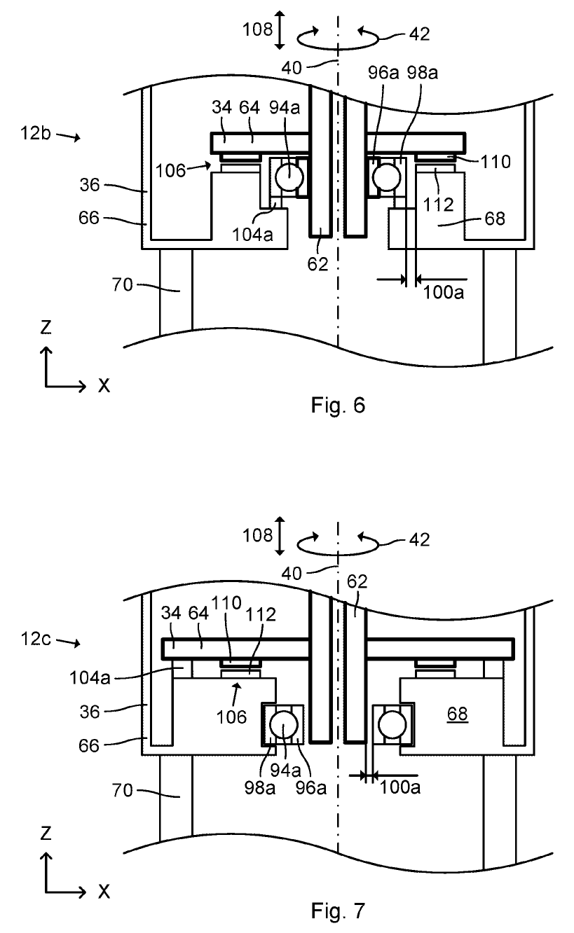

FIG. 6 schematically represents a partial cross-sectional side view of a further example of a wheel unit 12b. The wheel unit 12b differs from the wheel unit 12a in that the spring washer 104a is positioned between and contacts the steering bearing race 98a and the steering structure 36, here the steering support 68 thereof. Furthermore, there is a loose tolerance fit between the steering bearing race 98a and the steering structure 36 such that the gap 100a is formed therebetween. Moreover, the base bearing race 96a is fixed to the base structure 34, here to the base shaft 62 thereof. Also in this example, the spring washer 104a and the first steering bearing 94a is arranged in series between the base structure 34 and the steering structure 36, here between the base shaft 62 and the steering support 68. The spring washer 104a may or may not be fixed to any of the steering bearing race 98a and the steering structure 36.

FIG. 7 schematically represents a partial cross-sectional side view of a further example of a wheel unit 12c. The wheel unit 12c differs from the wheel unit 12a in that the spring washer 104a, the steering sensor 106 and the first steering bearing 94a are arranged in parallel between the base structure 34 and the steering structure 36. The spring washer 104a is positioned between and contacts each of the base structure 34, here the base support 64 thereof, and the steering structure 36, here the steering support 68 thereof. Thus, both rotational and axial movements with respect to the steering axis 40 occurs at the spring washer 104a in this example. The spring washer 104a may be fixed to only one of the base structure 34 and the steering structure 36, or may not be fixed to any of the base structure 34 and the steering structure 36.

The steering bearing race 98a is fixed to the steering structure 36, here to the steering support 68 thereof. The gap 100a is formed between the base bearing race 96a and the base structure 34, here the base shaft 62 thereof. There is thus a loose tolerance fit between the base bearing race 96a and the base structure 34.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

In the context of the present disclosure, a single sensor can be configured to both sense a rotational position and an axial position is commercially available. The sensor may be configured to output rotational position data indicative of the rotational position of the steering structure and axial position data indicative of the axial position of the base structure. The sensor may comprise a sensing part fixed to the base structure and a target part fixed to the steering structure, or vice versa.

Since the sensor senses the axial position of the base structure, and since the force device forces the base structure and the steering structure away from each other along the steering axis, the sensor provides load sensing functionality. For example, a vertical load acting downwards on the base structure may cause downward movement of the base structure relative to the steering structure and against the force of the force device. Based on the characteristics of a spring or other force device, and based on the axial position data, the vertical load can be determined, e.g., by using Hooke's law.

The wheel unit may comprise a steering motor arranged to drive rotation of the steering structure relative to the base structure around the steering axis. The steering motor may be arranged to directly drive the steering structure. The wheel unit may thus comprise a steerable wheel. The wheel unit according to the first aspect may however alternatively comprise a non-steerable wheel.

The wheel unit may comprise a drive motor arranged to drive rotation of the wheel relative to the steering structure around the wheel axis. In this case, the wheel may be a traction wheel. The drive motor may be arranged to directly drive the wheel. The wheel unit according to the first aspect may however alternatively comprise a wheel that is not drivable around the wheel axis.

The base structure may for example comprise a base, such as a platform. Alternatively, or in addition, the base structure may comprise a base support. The sensing part or the target part of the sensor may be fixed directly to the base support. Alternatively, or in addition, the base structure may comprise a vertically oriented base shaft. In case the wheel unit comprises a steering motor, a steering stator thereof may be fixed to, or form part of, the base structure.

The steering structure may for example comprise an arm part, a housing and/or a wheel shaft. According to one variant, the steering structure comprises an arm part interconnecting the housing and the wheel shaft. Alternatively, or in addition, the steering structure may comprise a steering support. The target part or the sensing part of the sensor may be fixed directly to the steering support. The steering support may be integrally formed with the housing or may be connected to the housing. In any case, the steering support may be arranged at an inside of the housing. In case the wheel unit comprises a drive motor, a drive stator thereof may be fixed to, or form part of, the steering structure.

The wheel unit may further comprise a bearing arranged to support rotation of the steering structure relative to the base structure around the steering axis.

The force device, the sensor and the bearing may be arranged between the base structure and the steering structure. For example, the force device, the sensor and the bearing may be arranged between the base support and the steering support.

The force device and the bearing may be arranged in series between the base structure and the steering structure. The force device may be fixed to one or both of the base structure and the steering structure.

The bearing may be a rolling element bearing.

The bearing may comprise a base bearing part associated with the base structure and a steering bearing part associated with the steering structure and rotatable relative to the base bearing part around the steering axis. With the base bearing part being associated with the base structure may be meant that the base bearing part is positioned between the base structure and the steering bearing part. Correspondingly, with the steering bearing part being associated with the steering structure may be meant that the steering bearing part is positioned between the steering structure and the base bearing part.

The force device may be arranged to contact the steering bearing part or the base bearing part. For example, in case the force device is arranged to contact the steering bearing part, the force device is not arranged to contact the base bearing part, and vice versa.

The wheel unit may further comprise a gap between the base bearing part and the base structure and/or between the steering bearing part and the steering structure. The gap may be a radial gap with respect to the steering axis. According to one variant, the base bearing part is fixed to the base structure but the steering bearing part is not fixed to the steering structure. In this case, a radial gap with respect to the steering axis may be formed between the steering bearing part and the steering structure. According to a further variant, the steering bearing part is fixed to the steering structure but the base bearing part is not fixed to the base structure. In this case, a radial gap with respect to the steering axis may be formed between the base bearing part and the base structure.

The force device may comprise a spring.

The force device may comprise a spring washer.

The base structure may comprise a base shaft concentric with the steering axis.

The sensor may have a resolution of less than 100 μm, such as less than 10 μm for the axial position.

The sensor may be enclosed by the steering structure around the steering axis. The sensor may thus be integrated inside of the wheel unit. The sensor may be enclosed by the housing of the steering structure.

According to a second aspect, there is provided an automated guided vehicle, AGV comprising a wheel unit according to the first aspect. The AGV may comprise a plurality of wheel units according to the first aspect, such as three or four wheel units.

The AGV may comprise a base. In this case, the base structure may be integrally formed with, or fixed to, the base. The base may for example be a platform.

The AGV may comprise a manipulator, such as a serial or parallel manipulator programmable in three or more axes. The manipulator may be supported on the base.

The AGV may further comprise a control system comprising at least one data processing device and at least one memory having at least one computer program stored therein, the at least one computer program comprising program code which, when executed by the at least one data processing device, causes the at least one data processing device to perform, or command performance of, various steps as described herein. The at least one computer program may comprise program code which, when executed by the at least one data processing device, causes the at least one data processing device to perform an operation based on the axial position data.

One example of such operation performed by the control system based on the axial position data may include a motion control of the AGV. Such motion control may include controlling a steering motor and/or a drive motor of one, several or all wheel units. For example, the control system may determine a contact force between the wheel and a ground surface for each wheel unit based on the axial position data. In this case, the control system may increase a traction force for one or more wheels having a relatively high contact force and/or decrease a traction force for one or more wheels having a relatively low contact force, lower than the relatively high contact force. To this end, a threshold value indicative of the contact force may be used by the control system, where the threshold value distinguishes the relatively high contact force from the relatively low contact force.

A further example of such operation performed by the control system based on the axial position data may include an inclination control of the AGV. Such inclination control may include determining an inclination of the base and commanding execution of a countermeasure if the inclination exceeds a threshold value to avoid tipping of the AGV. Reasons for the base being inclined may include that the AGV travels on a slope, due to a positioning of the manipulator, and/or due to a human pushing the AGV. The countermeasure may for example include a reactive motion control of the AGV and/or issuance of a warning.

A further example of such operation performed by the control system based on the axial position data may include a detection of overload on any of the wheel units.

A further example of such operation performed by the control system based on the axial position data may include a detection of whether an external force acts on the AGV. For example, in case the axial position of the base structure in one or more wheel units changes while the AGV, including any manipulator thereon, has been commanded to be positioned at standstill, it can be concluded that an external force acts on the AGV, such as a human pushing the AGV. Also a direction and a magnitude of the external force can be determined based on the axial position data from one or more wheel units.

The axial position data from one or more wheel units may also be used, e.g., by the control system, to monitor a remaining useful life of the AGV.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A wheel unit for an automated guided vehicle (AGV), the wheel unit comprising:
a base structure;
a steering structure rotatable relative to the base structure around a vertical steering axis; and
a wheel supported by the steering structure and rotatable relative to the steering structure around a horizontal wheel axis;
wherein the wheel unit comprises:
a force device arranged to force the base structure and the steering structure away from each other along the steering axis; and
a sensor arranged to sense a rotational position of the steering structure relative to the base structure around the steering axis and an axial position of the base structure relative to the steering structure along the steering axis.

2. The wheel unit of claim 1, further comprising a bearing arranged to support rotation of the steering structure relative to the base structure around the steering axis.

3. The wheel unit of claim 2, wherein the force device, the sensor and the bearing are arranged between the base structure and the steering structure.

4. The wheel unit of claim 2, wherein the force device and the bearing are arranged in series between the base structure and the steering structure.

5. The wheel unit of claim 2, wherein the bearing is a rolling element bearing.

6. The wheel unit of claim 2, wherein the bearing comprises a base bearing part associated with the base structure and a steering bearing part associated with the steering structure and rotatable relative to the base bearing part around the steering axis.

7. The wheel unit of claim 6, wherein the force device is arranged to contact the steering bearing part or the base bearing part.

8. The wheel unit of claim 6, further comprising a gap defined between the base bearing part and the base structure and/or between the steering bearing part and the steering structure.

9. The wheel unit of claim 1, wherein the force device comprises a spring.

10. The wheel unit of claim 1, wherein the force device comprises a spring washer.

11. The wheel unit of claim 1, wherein the base structure comprises a base shaft disposed concentrically with the steering axis.

12. The wheel unit of claim 1, wherein the sensor has a resolution of less than 100 μm for the axial position.

13. The wheel unit of claim 1, wherein the sensor is enclosed by the steering structure around the steering axis.

14. An automated guided vehicle (AGV), comprising:
a wheel unit, the wheel unit comprising:
a base structure;
a steering structure rotatable relative to the base structure around a vertical steering axis; and
a wheel supported by the steering structure and rotatable relative to the steering structure around a horizontal wheel axis;
wherein the wheel unit comprises:
a force device arranged to force the base structure and the steering structure away from each other along the steering axis; and
a sensor arranged to sense a rotational position of the steering structure relative to the base structure around the steering axis and an axial position of the base structure relative to the steering structure along the steering axis.

15. The AGV of claim 14, wherein the sensor is configured to output axial position data indicative of an axial position of the steering structure, and wherein the AGV further comprises a control system comprising at least one data processing device and at least one memory having at least one computer program stored therein, the at least one computer program comprising program code which, when executed by the at least one data processing device, causes the at least one data processing device to perform an operation based on the axial position data.
